(19) United States
(12) Patent Application Publication
(10) Pub. No.: US 2026/0298703 A1
(43) Pub. Date: Oct. 1, 2026

(54) THREE-DIMENSIONAL VIBRATION FIBER BRAGG GRATING SENSOR FOR ENGINEERING PARAMETER SUB FOR LOGGING WHILE DRILLING

(71) Applicant: Wuhan University of Technology, Wuhan (CN)

(72) Inventors: Lei Liang, Wuhan (CN); Ke Jiang, Wuhan (CN); Xiaoling Tong, Wuhan (CN); Shu Dai, Wuhan (CN); Chuang Rao, Wuhan (CN)

(21) Appl. No.: 19/393,541

(22) Filed: Nov. 18, 2025

Related U.S. Application Data
(63) Continuation of application No. PCT/CN2025/130812, filed on Oct. 29, 2025.

(30) Foreign Application Priority Data
Mar. 25, 2025 (CN) 2025103583486

(51) Int. Cl. G01H 9/00

(52) U.S. Cl. CPC G01H 9/006

(57) ABSTRACT

The present application proposes a three-dimensional vibration fiber Bragg grating sensor for an engineering parameter sub for logging while drilling, and belongs to the technical field of fiber Bragg grating sensors. The sensor includes a hollow shell with fiber inlet and outlet ports. Three support assemblies are sequentially arranged in the shell in an axial direction, and normal directions of end faces for slots on the three support assemblies are mutually different. A bend-insensitive optical fiber sequentially passes through all the slots, grating regions are arranged on corresponding optical fiber sections, and the grating regions and the support assemblies form sensing bodies for acquiring multi-axial-direction vibration signals.

The present application claims priority to Chinese patent application No. 202510358348.6 filed on Mar. 25, 2025 to the China National Intellectual Property Administration, and entitled “THREE-DIMENSIONAL VIBRATION FIBER BRAGG GRATING SENSOR FOR ENGINEERING PARAMETER SUB FOR LOGGING WHILE DRILLING”, the entire content of which is incorporated herein by reference.

### TECHNICAL FIELD

The present application relates to the technical field of fiber Bragg grating sensors, and in particular to a three-dimensional vibration fiber Bragg grating sensor for an engineering parameter sub for logging while drilling.

### BACKGROUND

A while-drilling fiber optic communication technology is an advanced communication technology used in the oil and gas industry. This technology is based on the field of fiber optic communication. Due to the very high frequency of its light waves, fiber optic communication offers greater transmission capacity and wider bandwidth than ordinary cable communication, making it suitable for high-speed and broadband information transmission. The loss of optical fibers is very small, which can greatly extend the distance of repeaterless transmission. Fiber optic communication transmits optical signals with virtually no external radiation, offers superior confidentiality, while prevents crosstalk between optical fibers within the same optical cable, is immune to electromagnetic interference, and does not generate electrical sparks that cause safety hazards to oil wells, with good explosion-proof performance. A raw material for making glass optical fibers is quartz stone, which is more abundant than copper, aluminum, etc. for making cables. Furthermore, optical fibers are environmentally friendly and have a long service life.

During a downhole measurement while drilling process, accurate measurement of three-dimensional vibration parameters near a drill bit is of great significance for safe and efficient drilling of the drilling process. However, most downhole vibration sensors adopted by existing measurement while drilling technologies are electrical sensors. In a harsh downhole environment of high temperature, high pressure, and strong electromagnetic interference, the application cost of corresponding electrical sensors is high. Meanwhile, if a downhole electrical sensor is applied to an optical fiber measurement while drilling system, an optoelectronic conversion module needs to be designed additionally, thereby increasing the risk to the safe operation of the solution. A fiber Bragg grating sensing technology has advantages of high temperature and pressure resistance, as well as electromagnetic interference resistance, and has been widely applied in the field of petroleum engineering monitoring. A fiber Bragg grating sensor can directly access the optical fiber measurement while drilling system, enabling efficient transmission of collected physical quantity information through optical signals. In the application of the downhole optical fiber measurement while drilling system, a large basic optical transmission loss exists, primarily caused by the following two reasons. First, the optical fiber measurement while drilling system requires a plurality of optical fiber connectors to be connected to form a complete link. Its required optical fiber connectors include downhole wet connectors, wellhead wet connectors, and photoelectric slip rings. The coordination of these connectors can solve the problem of difficult optical cable installation, thereby simplifying the process flow and improving construction efficiency. However, the use of these connectors increases the basic optical transmission loss of the optical fiber measurement while drilling system. Meanwhile, the harsh downhole operating environment of high temperature and pressure accelerates the aging and deformation of sealing rings, leading to the intrusion of moisture and contaminants, thereby causing a secondary increase in optical transmission loss of the fiber optic communication while drilling system. Second, since an optical cable needs to be continuously released during the process of optical fiber measurement while drilling, a main coiling box and a relay coiling box each need to store a certain length of optical cable in the coiling boxes. The optical cable is spirally wound around a cable rod in the coiling box. A macrobend loss brought about by this spiral winding mode further increases the basic loss of the optical fiber measurement while drilling system. On the other hand, to meet engineering operation requirements for high-temperature and high-pressure resistance, the design of engineering parameter subs of a downhole drill pipe should strive to ensure the service strength of the subs. Therefore, a sensor installation area designed in an engineering parameter sub is typically small in size and in a flat shape. In summary, designing a low-loss fiber Bragg grating three-dimensional vibration sensor in a confined space is a major challenge for its application in downhole optical fiber measurement while drilling.

Therefore, it is very necessary to provide a three-dimensional vibration fiber Bragg grating sensor for an engineering parameter sub for logging while drilling, which adopts a linear separated arrangement mode, placing sensing units of three dimensions on the same straight line and utilizing vibrations in three axial directions on one single-mode fiber to achieve an output while drilling in a compact structure.

### SUMMARY

In view of this, the present application proposes a three-dimensional vibration fiber Bragg grating sensor for an engineering parameter sub for logging while drilling that is compact in structure, may be configured to measure vibration acceleration in three axial directions, and is suitable for outputting while drilling in an application scenario of an engineering parameter sub for logging.

The present application provides a three-dimensional vibration fiber Bragg grating sensor for an engineering parameter sub for logging while drilling, including:
a hollow shell, wherein two ends of the shell extending in a first preset direction are respectively provided with a fiber inlet port and a fiber outlet port, the first preset direction is a length extension direction of the shell, and the shell is fixedly connected to the engineering parameter sub;
three support assemblies, arranged in the shell sequentially and at intervals in the first preset direction, wherein the three support assemblies are each provided with a through slot, and normal directions of end faces where the slots are formed on the three support assemblies are mutually different; and
a bend-insensitive optical fiber, arranged on the shell in a penetrating mode and sequentially passing through the fiber inlet port, the slots on the three support assemblies, and the fiber outlet port, wherein a grating region is arranged on a part of the bend-insensitive optical fiber passing through each of the three support assemblies;
wherein each grating region and the support assembly where the grating region is located together form a sensing body, and the sensing body is configured to acquire vibration signals of different axial directions during a logging-while-drilling process.

In some embodiments, the three support assemblies each include a fixing seat, a cantilever beam, and a mass block. The fixing seat is fixedly connected to an inner surface of the shell, the mass block and the fixing seat are spaced apart, the slot penetrates through the mass block and the fixing seat of the same support assembly, end faces of the mass block and the fixing seat where the slot is formed are flush, and the cantilever beam is arranged between the mass block and the fixing seat and is fixedly connected to adjacent end faces of the mass block and the fixing seat respectively; the bend-insensitive optical fiber is fixedly connected to parts of the slot in the mass block and the fixing seat respectively; the grating region of the bend-insensitive optical fiber is suspended between the mass block and the fixing seat in a tensioned mode and is arranged at a gap with the cantilever beam; and the mass block and the cantilever beam are arranged at a gap with the inner surface of the shell.

In some embodiments, a thickness of the cantilever beam in the radial direction of the bend-insensitive optical fiber is less than a thickness of the fixing seat or the mass block in the radial direction of the bend-insensitive optical fiber, and mass of the cantilever beam is less than mass of the mass block.

In some embodiments, when a vibration signal of external drilling acts on the three sensing bodies, under action of inertia, one ends of the cantilever beams away from the fixing seats, and the mass blocks undergo axial offsets, compressing or stretching the grating regions on the three sensing bodies, so that a central wavelength of reflected light of the grating regions changes, and the vibration signal of external drilling is obtained by performing signal demodulation on the reflected light of the grating regions; and each mass block undergoing an axial offset is a rotation with respect to an end face, where the slot is formed, of the fixing seat of the sensing body where the mass block is located.

In some embodiments, a surface of the bend-insensitive optical fiber is bonded to an inner surface of the slot, or metal plating is arranged on a part of the surface of the bend-insensitive optical fiber located at the sensing body, and the metal plating is welded and fixed to the inner surface of the slot; and a depth of the slot is greater than a diameter of the bend-insensitive optical fiber, and a width of the slot is equal to the diameter of the bend-insensitive optical fiber.

In some embodiments, let a length of the cantilever beam be L, and a cross-sectional area of the cantilever beam be A=wh, where w is a current width of the cantilever beam, h is a current thickness of the cantilever beam, w₀ is an initial width of the cantilever beam, h₀ is an initial thickness of the cantilever beam, a distance from a center of the mass block to an end of the fixing seat near the cantilever beam is L2, a length of the mass block in an axial direction of the bend-insensitive optical fiber is d, a thickness of the mass block in a radial direction of the bend-insensitive optical fiber is e, total mass of the mass block and the cantilever beam is M, E is an elastic modulus of the cantilever beam, and I is an area moment of inertia of the cantilever beam; influences of temperature T and pressure P on material parameters and geometric dimensions are introduced, a corrected elastic modulus is E(T,P)=E₀(1+βΔT)(1+γP), where E₀ is an initial value of the elastic modulus, β is a temperature coefficient of the elastic modulus, γ is a pressure coefficient of the elastic modulus, ΔT is the amount of a temperature change, and P is a current pressure; a corrected length of the cantilever beam is L(T,p)=L₀(1+α_{T}ΔT)(1−δP), L₀ is an initial length of the cantilever beam, α_{T} is a thermal expansion coefficient of the cantilever beam, and δ is a compression coefficient of the cantilever beam; a corrected distance from the center of the mass block to the end of the fixing seat near the cantilever beam is L₂(T,P)=L₂₀ (1+α_{T}ΔT)(1−δP), and L₂₀ is an initial length from the center of the mass block to a nearest end of the fixing seat; a corrected area moment of inertia is I(T,P)=I(1+α_{T}ΔT−δ_{w}P)(1+α_{T}ΔT−δₕP)³, δ_{w} is a width compression coefficient, and δₕ is a height compression coefficient; a corrected thickness of the mass block in the radial direction of the bend-insensitive optical fiber is e(T,P)=e₀(1+αₑΔT)(1−δₑP), e₀ is an initial height of the mass block, αₑ is a thermal expansion coefficient of the mass block, and δₑ is a compression coefficient of the mass block; a corrected grating reflection wavelength is λ_{B}(T,P)=λ_{B0} [1+(α_{λ}+ξΔT)+(1−Pₑ)F_{P}], λ_{B0} is an initial central wavelength of the grating region, α_{λ} is a thermal expansion coefficient of an optical fiber, ξ is a thermo-optic coefficient of an optical fiber, Pₑ is an elasto-optic coefficient, and F_{P} is a pressure-induced axial strain of an optical fiber; following relations are satisfied: a first axial sensitivity is

$${S}_{x} ( T , P ) = \frac{[ M \cdot e ( T , P ) \cdot {λ}_{B} ( T , P ) ( 1 - {P}_{e} ) ] [ 2 L ( T , P ) {L}_{2} ( T , P ) - {L}_{2}^{2} ( T , P ) ]}{4 E ( T , P ) {I}_{x} ( T , P ) L ( T , P )} ;$$

a second axial sensitivity is

$${S}_{y} ( T , P ) = \frac{[ M \cdot e ( T , P ) \cdot {λ}_{B} ( T , P ) ( 1 - {P}_{e} ) ] [ 2 L ( T , P ) {L}_{2} ( T , P ) - {L}_{2}^{2} ( T , P ) ]}{4 E ( T , P ) {I}_{y} ( T , P ) L ( T , P )} ;$$

and a third axial sensitivity is

$${S}_{z} ( T , P ) = \frac{M \cdot {λ}_{B} ( T , P ) ( 1 - {P}_{e} )}{E ( T , P ) A} ,$$

where

$${I}_{x} ( T , P ) = {I}_{x 0} ( 1 + {α}_{T} Δ T - {δ}_{w} P ) {( 1 + {α}_{T} Δ T - {δ}_{h} P )}^{3} , {I}_{x 0} = \frac{{w}_{0} {h}_{0}^{3}}{12}$$

is a first initial moment of inertia, and

$${I}_{y} ( T , P ) = {I}_{y 0} ( 1 + {α}_{T} Δ T - {δ}_{w} P ) {( 1 + {α}_{T} Δ T - {δ}_{h} P )}^{3} , {I}_{y 0} = \frac{{h}_{0} {w}_{0}^{3}}{12}$$

is a second initial moment of inertia.

In some embodiments, measurement wavelength ranges of the different grating regions do not overlap each other.

In some embodiments, the three-dimensional vibration fiber Bragg grating sensor further includes a plurality of installation blocks, the inner surface of the shell is provided with a plurality of placement grooves, and the plurality of placement grooves are spaced apart in the first preset direction; one ends of the installation blocks are embedded in the placement grooves, and the other ends extend out of the placement grooves and extend toward an interior of the shell; and the fixing seats are arranged at ends of the plurality of installation blocks away from the inner surface of the shell, and are fixedly connected to the installation blocks.

In some embodiments, spacing between the different fixing seats is greater than spacing between the corresponding installation blocks.

In some embodiments, the three-dimensional vibration fiber Bragg grating sensor further includes a cover plate, the shell is provided with an opening, and the cover plate covers the opening.

### BRIEF DESCRIPTION OF DRAWINGS

FIG. 1 is a front view of a three-dimensional vibration fiber Bragg grating sensor for an engineering parameter sub for logging while drilling after a cover plate is hidden disclosed in the present application;

FIG. 2 is a three-dimensional view of a three-dimensional vibration fiber Bragg grating sensor for an engineering parameter sub for logging while drilling after a cover plate and a bend-insensitive optical fiber are hidden disclosed in the present application;

FIG. 3 is a three-dimensional view of an exploded state of a three-dimensional vibration fiber Bragg grating sensor for an engineering parameter sub for logging while drilling after a cover plate and a bend-insensitive optical fiber are hidden disclosed in the present application;

FIG. 4 is a front view of a fit state of installation blocks and placement grooves of a shell of a three-dimensional vibration fiber Bragg grating sensor for an engineering parameter sub for logging while drilling disclosed in the present application;

FIG. 5 is a front view of a three-dimensional vibration fiber Bragg grating sensor for an engineering parameter sub for logging while drilling after an installation block is removed disclosed in the present application;

FIG. 6 is a top view of a support assembly of a three-dimensional vibration fiber Bragg grating sensor for an engineering parameter sub for logging while drilling disclosed in the present application;

FIG. 7 is a front view of a support assembly of a three-dimensional vibration fiber Bragg grating sensor for an engineering parameter sub for logging while drilling disclosed in the present application; and

FIG. 8 is a schematic diagram of relative positions of a bend-insensitive optical fiber, three support assemblies, and a shell prior to assembly of a three-dimensional vibration fiber Bragg grating sensor for an engineering parameter sub for logging while drilling disclosed in the present application.

### DETAILED DESCRIPTION

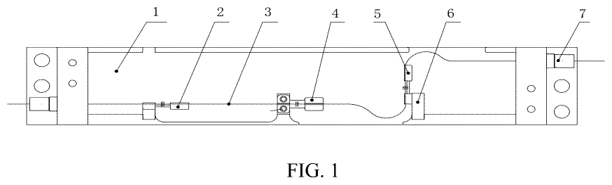

Designing a low-loss fiber Bragg grating three-dimensional vibration sensor in a confined space is a major challenge for its application in downhole optical fiber measurement while drilling. A conventional optical fiber winding mode as well as a connection mode of a plurality of optical fiber connectors bring macrobend loss and transmission loss. In view of this, as can be seen in conjunction with FIGS. 1, 2, and 3, an embodiment of the present application provides a three-dimensional vibration fiber Bragg grating sensor for an engineering parameter sub for logging while drilling, including:

a hollow shell 1, wherein two ends of the shell 1 extending in a first preset direction are respectively provided with a fiber inlet port and a fiber outlet port 7, the first preset direction is a length extension direction of the shell 1, i.e., a horizontal extension direction shown in FIG. 1. The shell 1 is fixedly connected to the engineering parameter sub. The fiber inlet port and the fiber outlet port 7 arranged at the two ends of the shell 1 are used for sealed passing of an optical fiber to prevent the interior of the shell 1 from being contaminated, and the interior of the shell 1 can be provided with a bolt hole so as to be in a threaded connection with the engineering parameter sub.

In some embodiments, the shell 1 is also provided with a cover plate, an end face of a side of the shell 1 away from the engineering parameter sub is provided with an opening, and the cover plate covers the opening. The cover plate is not shown in the accompanying drawings.

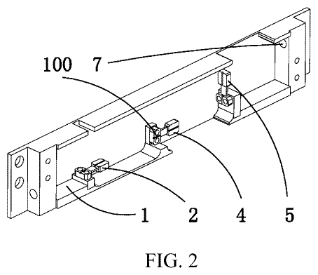

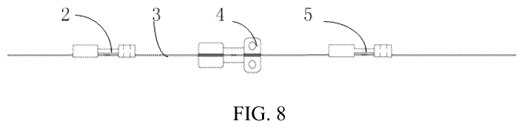

Three support assemblies are arranged in the shell 1 sequentially and at intervals in the first preset direction, wherein the three support assemblies are each provided with a through slot 100, and normal directions of end faces where the slots 100 are formed on the three support assemblies are mutually different. The slots 100 are configured to hold the optical fiber. As shown in FIG. 2 in conjunction with FIG. 8, the three support assemblies are, for the purpose of differentiation, a first support assembly 2, a second support assembly 4 and a third support assembly 5 respectively. As can be seen in FIG. 1, the end face of the first support assembly 2 where the slot 100 is formed is arranged horizontally, the normal direction of the end face where the slot 100 is formed is vertically upward, and the direction is defined as an X-axis direction. The end face of the second support assembly 4 where the slot 100 is formed is arranged vertically, the normal direction of the end face where the slot 100 is formed is vertically planar outward, and the direction is defined as a Y-axis direction. The end face of the third support assembly 5 where the slot 100 is formed is arranged vertically, the normal direction of the end face where the slot 100 is formed is the opposite direction of the first preset direction, and the direction is defined as a Z-axis direction.

A bend-insensitive optical fiber 3 is arranged on the shell 1 in a penetrating mode and sequentially passing through the fiber inlet port, the slots 100 on the three support assemblies, and the fiber outlet port 7, and a grating region 200 is arranged on a part of the bend-insensitive optical fiber 3 passing through each of the three support assemblies. A fiber Bragg grating is sensitive to parameters such as stress or acceleration, an external force causes a central wavelength of reflected light in the grating region 200 to drift, and by demodulating the amount of wavelength drift of a reflected light signal, the magnitude of a physical quantity to be measured loaded in the grating region 200 can be back-calculated.

In this embodiment, the grating region 200 and the support assembly where the grating region is located together form a sensing body, and the sensing body is configured to acquire vibration signals of different axial directions during a logging-while-drilling process. The attitudes of the sensing bodies are limited by successively arranging three support assemblies in the shell 1 in different orientations, thereby reducing the overall length of the bending-insensitive optical fiber 3, which is conducive to reducing the bending loss of the optical fiber, and improving the transmission quality of the optical signal detected by sensing. In practice, it is necessary to rotate the shell 1 shown in FIG. 1 by 900 clockwise, and vertical placement is the attitude at work. According to the rules of a right-handed coordinate system, a thumb, an index finger and a middle finger are pointed in different directions and perpendicular to each other, a face where the thumb and the index finger are located is the end face where the slot 100 is formed, the direction pointed by the middle finger is the normal direction of the end face of each support assembly where the slot 100 is formed. Similarly the sensing bodies where the three support assemblies are located are named a first sensing body, a second sensing body and a third sensing body respectively according to the first preset direction.

In some embodiments, measurement wavelengths of the three grating regions 200 inscribed on a fully insensitive optical fiber are different from each other. In order to avoid mutual interference of the reflected light signals of the different grating regions 200, measurement wavelength ranges of the different grating regions 200 do not overlap each other. For example, an upper limit of the measurement wavelength range of the grating region 200 of the first sensing body differs from a lower limit of the measurement wavelength range of the second sensing body by at least 5 nm. An upper limit of the measurement wavelength range of the second sensing body differs from a lower limit of the measurement wavelength range of the third sensing body by at least 5 nm. This may avoids the phenomenon of wavelength overlapping due to too small a wavelength interval in the grating region 200 during operation. The three grating regions 200 correspond to measuring vibration sensing detection on the X-axis, Y-axis, and Z-axis respectively, and the vibration sensing measurement can be performed simply by detecting the central wavelength drift of the measurement wavelength range of the corresponding grating region 200.

The present application arranges a separate bend-insensitive optical fiber inside the compact shell, and three gratings are arranged on the optical fiber, and in combination with three support assemblies, form three different sensing bodies, so as to measure the vibration signals in the three axial directions of the engineering parameter sub, which reduces the bending loss of the sensor, and improves the reliability of the sensor's measurement results and the transmission quality.

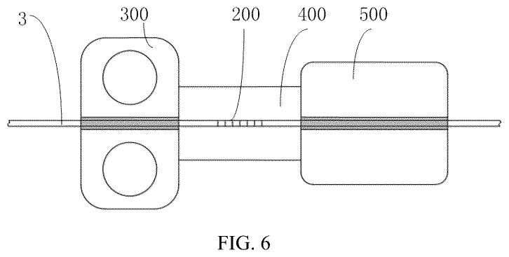

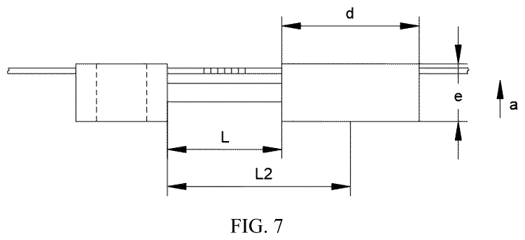

As shown in FIGS. 6, 7, and 8, the three support assemblies each include a fixing seat 300, a cantilever beam 400, and a mass block 500. The fixing seat 300 is fixedly connected to an inner surface of the shell 1, the mass block 500 and the fixing seat 300 are spaced apart, the slot 100 penetrates through the mass block 500 and the fixing seat 300 of the same support assembly, end faces of the mass block 500 and the fixing seat 300 where the slot 100 is formed are flush, and the cantilever beam 400 is arranged between the mass block 500 and the fixing seat 400 and is fixedly connected to adjacent end faces of the mass block 500 and the fixing seat 300 respectively. The bend-insensitive optical fiber 3 is fixedly connected to parts of the slot 100 in the mass block 500 and the fixing seat 300 respectively; the grating region 200 of the bend-insensitive optical fiber 3 is suspended between the mass block 500 and the fixing seat 300 in a tensioned mode and is arranged at a gap with the cantilever beam 400; and the mass block 500 and the cantilever beam 400 are arranged at a gap with the inner surface of the shell 1. The cantilever beams 400 are not in contact with the grating regions 200, and under the action of axial vibration, the two ends of the grating regions 200 on the different sensing bodies are axially stretched or compressed by the corresponding fixing seats 300 and the mass blocks 500 respectively, so that the grating regions 200 drift to the initial central wavelength of the reflected light, and the sensitive measurement of the vibration can be achieved by demodulating the reflected light signals after the drift.

In some embodiments, a thickness of the cantilever beam 400 in the radial direction of the bend-insensitive optical fiber 3 is less than a thickness of the fixing seat 300 or the mass block 500 in the radial direction of the bend-insensitive optical fiber 3, and mass of the cantilever beam 400 is less than mass of the mass block 500. If the mass of the cantilever beam 400 is much less than the mass of the mass block 500, the cantilever beam 400 and the mass block 500 can be treated as a whole.

In some other embodiments, spacing between the different fixing seats 300 is greater than spacing between the corresponding installation blocks. This arrangement is to reduce the bending loss due to excessive bending of the optical fiber during installation, while sufficient installation margin needs to be left.

As shown in FIG. 1 in conjunction with FIG. 8, before installing the sensor in the shell 1, it is necessary to pre-fix the three support assemblies sequentially with the bend-insensitive optical fiber 3 in the illustrated orientation, and the change in the arrangement direction of the sensing body can effectively avoid the accident of breakage of the optical fiber due to a torsional shear force on the optical fiber during the installation process, so that it is possible to obtain the three sensing bodies located on the same bend-insensitive optical fiber 3 by encapsulation. It should be noted that when the second sensing body and the third sensing body in FIG. 1 are installed on the shell 1, it is necessary to ensure that the radius of curvature formed by the installation is larger than a smallest bending radius of the optical fiber, so as to also reduce the bending loss generated by the optical fiber due to excessive bending during the installation, and at the same time, it is also necessary to leave a sufficient installation margin for the three sensing bodies in the shell 1.

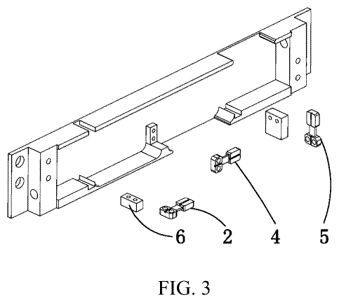

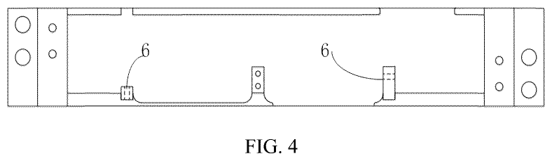

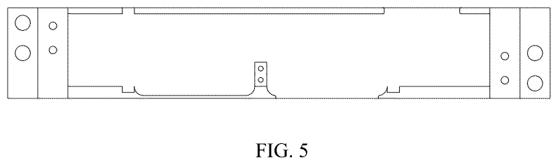

As shown in FIGS. 3, 4 and 5, in order to ensure that the respective sensing bodies do not come into direct contact with the inner surface of the shell 1, a plurality of installation blocks 6 are also arranged within the shell 1, the inner surface of the shell 1 is provided with a plurality of placement grooves, and the plurality of placement grooves are spaced apart in the first preset direction; one ends of the installation blocks 6 are embedded in the placement grooves, and the other ends extend out of the placement grooves and extend toward an interior of the shell 1; and the fixing seats 300 are arranged at ends of the plurality of installation blocks 6 away from the inner surface of the shell 1, and are fixedly connected to the installation blocks 6. The fixing seats 300 and the installation blocks 6 may be fixed by a threaded connection or by welding. The installation blocks 6 can be fixedly connected to the shell 1 by welding.

In some embodiments, when a vibration signal of external drilling acts on the three sensing bodies, under action of inertia, one ends of the cantilever beams 400 away from the fixing seats 300, and the mass blocks 500 undergo axial offsets, compressing or stretching the grating regions 200 on the three sensing bodies, so that a central wavelength of reflected light of the grating regions 200 changes, and the vibration signal of external drilling is obtained by performing signal demodulation on the reflected light of the grating regions 200; and each mass block 500 undergoing an axial offset is a rotation with respect to an end face, where the slot 100 is formed, of the fixing seat 300 of the sensing body where the mass block is located. That is, the mass block 500 rotates at a certain angle clockwise or counterclockwise with respect to the end face of the fixing seat 300 where the slot 100 is formed.

Let a length of the cantilever beam 400 be L, and a cross-sectional area of the cantilever beam 400 be A=wh, where w is a current width of the cantilever beam 400, h is a current thickness of the cantilever beam 400, w₀ is an initial width of the cantilever beam 400, h₀ is an initial thickness of the cantilever beam 400, a distance from a center of the mass block 500 to an end of the fixing seat 300 near the cantilever beam 400 is L2, a length of the mass block 500 in an axial direction of the bend-insensitive optical fiber 3 is d, a thickness of the mass block 500 in a radial direction of the bend-insensitive optical fiber 3 is e, total mass of the mass block 500 and the cantilever beam 400 is M, E is an elastic modulus of the cantilever beam 400, and I is an area moment of inertia of the cantilever beam 400. If subjected to an external acceleration of a, the angle θ(L) of rotation of the cantilever beam 400 at the end away from the fixing seat 300 is

$$θ ( L ) = \frac{2 {MaLL}_{2} - {MaL}^{2}}{2 EI} ,$$

as be seen from the mechanics of materials analysis. The formula is for the angle in the ideal state.

Influences of temperature T and pressure P on material parameters and geometric dimensions are introduced, a corrected elastic modulus is E(T,P)=E₀(1+βΔT)(1+γP), where E₀ is an initial value of the elastic modulus, β is a temperature coefficient of the elastic modulus, γ is a pressure coefficient of the elastic modulus, ΔT is the amount of a temperature change, and P is a current pressure; a corrected length of the cantilever beam 400 is L(T,p)=L₀(1+α_{T}ΔT)(1−δP), L₀ is an initial length of the cantilever beam 400, α_{T} is a thermal expansion coefficient of the cantilever beam 400, and 8 is a compression coefficient of the cantilever beam 400; a corrected distance from the center of the mass block 500 to the end of the fixing seat 300 near the cantilever beam 400 is L₂(T,P)=L₂₀ (1+α_{T}ΔT)(1−δP), and L₂₀ is an initial length from the center of the mass block 500 to a nearest end of the fixing seat 300; a corrected area moment of inertia is I(T,P)=I₀(1+α_{T}ΔT−δ_{w}P)(1+α_{T}ΔT−δₕP)³, δ_{w} is a width compression coefficient, and δₕ is a height compression coefficient; a corrected thickness of the mass block 500 in the radial direction of the bend-insensitive optical fiber 3 is e(T,P)=e₀(1+αₑΔT)(1−δₑP), e₀ is an initial height of the mass block 500, αₑ is a thermal expansion coefficient of the mass block 500, and δₑ is a compression coefficient of the mass block 500; a corrected grating reflection wavelength is λ_{B}(T,P)=λ_{B0}[1=(α_{λ}+ξΔT)+(1−Pₑ)F_{P}], λ_{B0} is an initial central wavelength of the grating region 200, α_{λ} is a thermal expansion coefficient of an optical fiber, ξ is a thermo-optic coefficient of an optical fiber, Pₑ is an elasto-optic coefficient, and F_{P} is a pressure-induced axial strain of an optical fiber; following relations are satisfied: a first axial sensitivity is

$${S}_{x} ( T , P ) = \frac{[ M \cdot e ( T , P ) \cdot {λ}_{B} ( T , P ) ( 1 - {P}_{e} ) ] [ 2 L ( T , P ) {L}_{2} ( T , P ) - {L}_{2}^{2} ( T , P ) ]}{4 E ( T , P ) {I}_{x} ( T , P ) L ( T , P )} ;$$

a second axial sensitivity is

$${S}_{y} ( T , P ) = \frac{[ M \cdot e ( T , P ) \cdot {λ}_{B} ( T , P ) ( 1 - {P}_{e} ) ] [ 2 L ( T , P ) {L}_{2} ( T , P ) - {L}_{2}^{2} ( T , P ) ]}{4 E ( T , P ) {I}_{y} ( T , P ) L ( T , P )} ;$$

and a third axial sensitivity is

$${S}_{z} ( T , P ) = \frac{M \cdot {λ}_{B} ( T , P ) ( 1 - {P}_{e} )}{E ( T , P ) A} ,$$

where

$${I}_{x} ( T , P ) = {I}_{x 0} ( 1 + {α}_{T} Δ T - {δ}_{w} P ) {( 1 + {α}_{T} Δ T - {δ}_{h} P )}^{3} , {I}_{x 0} = \frac{{w}_{0} {h}_{0}^{3}}{12}$$

is a first initial moment of inertia, and

$${I}_{y} ( T , P ) = {I}_{y 0} ( 1 + {α}_{T} Δ T - {δ}_{w} P ) {( 1 + {α}_{T} Δ T - {δ}_{h} P )}^{3} , {I}_{y 0} = \frac{{h}_{0} {w}_{0}^{3}}{12}$$

is a second initial moment of inertia. The parameters L and L2, E and I in the rotation angle formula are replaced with the corrected L(T,p), L₂(T,P), E(T,P) and I(T,P) respectively. The angle θ(L,T,P) of rotation of the cantilever beam 400 at the end away from the fixing seat 300 after the temperature and pressure corrections can be obtained.

In this embodiment, the support assemblies each include a fixing seat 300 for fixing, a mass block 500 for overhanging out, and a cantilever beam 400 connecting the fixing seat 300 and the mass block 500. Under the influence of axial acceleration, the mass block 500 undergoes a certain axial deformation with respect to the fixing seat 300, which causes the grating region 200 to be compressed or stretched, causing the center wavelength of the emitted light of the grating region 200 to drift. By demodulating the optical signal, the amount of change in the central wavelength and the actual size of the current cantilever beam 400 can be obtained, and the angle of rotation of the cantilever beam 400 can be obtained by back-calculating.

It is noteworthy that the influence of the temperature and pressure of the operating environment of the engineering parameter sub is taken into account in the calculation of the axial sensitivity, which makes the sensitivity in each axial direction more accurate.

In some embodiments, the fixing mode of the surface of the bend-insensitive optical fiber 3 and the slot 100 may be that the surface of the bend-insensitive optical fiber 3 is bonded to an inner surface of the slot 100, or metal plating is arranged on a part of the surface of the bend-insensitive optical fiber located at the sensing body, and the metal plating is welded and fixed to the inner surface of the slot 100; and a depth of the slot 100 is greater than a diameter of the bend-insensitive optical fiber 3, and a width of the slot 100 is equal to the diameter of the bend-insensitive optical fiber 3. This combination mode provides a greater area of attachment to the surface of the bend-insensitive optical fiber 3.

What is claimed is:

1. A three-dimensional vibration fiber Bragg grating sensor for an engineering parameter sub for logging while drilling, comprising:
a hollow shell, wherein two ends of the shell extending in a first preset direction are respectively provided with a fiber inlet port and a fiber outlet port, the first preset direction is a length extension direction of the shell, and the shell is fixedly connected to the engineering parameter sub;
three support assemblies, arranged in the shell sequentially and at intervals in the first preset direction, wherein the three support assemblies are each provided with a through slot, and normal directions of end faces where the slots are formed on the three support assemblies are mutually different; and
a bend-insensitive optical fiber, arranged on the shell in a penetrating mode and sequentially passing through the fiber inlet port, the slots on the three support assemblies, and the fiber outlet port, wherein a grating region is arranged on a part of the bend-insensitive optical fiber passing through each of the three support assemblies;
wherein each grating region and the support assembly where the grating region is located together form a sensing body, and the sensing body is configured to acquire vibration signals of different axial directions during a logging-while-drilling process;
the three support assemblies each comprise a fixing seat, a cantilever beam, and a mass block;
let a length of the cantilever beam be L, and a cross-sectional area of the cantilever beam be A=wh, where w is a current width of the cantilever beam, h is a current thickness of the cantilever beam, w0 is an initial width of the cantilever beam, h0 is an initial thickness of the cantilever beam, a distance from a center of the mass block to an end of the fixing seat near the cantilever beam is L2, a length of the mass block in an axial direction of the bend-insensitive optical fiber is d, a thickness of the mass block in a radial direction of the bend-insensitive optical fiber is e, total mass of the mass block and the cantilever beam is M, E is an elastic modulus of the cantilever beam, and I is an area moment of inertia of the cantilever beam; influences of temperature T and pressure P on material parameters and geometric dimensions are introduced, a corrected elastic modulus is E(T,P)=E₀(1+βΔT)(1+γP), where E₀ is an initial value of the elastic modulus, β is a temperature coefficient of the elastic modulus, γ is a pressure coefficient of the elastic modulus, ΔT is the amount of a temperature change, and P is a current pressure; a corrected length of the cantilever beam is L(T,p)=L₀(1+α_{T}ΔT)(1−δP), L₀ is an initial length of the cantilever beam, α_{T} is a thermal expansion coefficient of the cantilever beam, and δ is a compression coefficient of the cantilever beam; a corrected distance from the center of the mass block to the end of the fixing seat near the cantilever beam is L₂(T,P)=L₂₀ (1+α_{T}ΔT)(1−δP), and L₂₀ is an initial length from the center of the mass block to a nearest end of the fixing seat; a corrected area moment of inertia is I(T,P)=I₀(1+α_{T}ΔT−δ_{w}P)(1+α_{T}ΔT−δₕP)³, δ_{w} is a width compression coefficient, and δₕ is a height compression coefficient; a corrected thickness of the mass block in the radial direction of the bend-insensitive optical fiber is e(T,P)=e₀ (1+αₑΔT)(1−δₑP), e₀ is an initial height of the mass block, αₑ is a thermal expansion coefficient of the mass block, and δₑ is a compression coefficient of the mass block; a corrected grating reflection wavelength is λ_{B}(T,P)=λ_{B0}[1+(α_{λ}+ξΔT)+(1−Pₑ)F_{P}], λ_{B0} is an initial central wavelength of the grating region, α_{λ} is a thermal expansion coefficient of an optical fiber, is a thermo-optic coefficient of an optical fiber, Pₑ is an elasto-optic coefficient, and F_{P} is a pressure-induced axial strain of an optical fiber; following relations are satisfied: a first axial sensitivity is
$${S}_{x} ( T , P ) = \frac{[ M \cdot e ( T , P ) \cdot {λ}_{B} ( T , P ) ( 1 - {P}_{e} ) ] [ 2 L ( T , P ) {L}_{2} ( T , P ) - {L}_{2}^{2} ( T , P ) ]}{4 E ( T , P ) {I}_{x} ( T , P ) L ( T , P )} ;$$
a second axial sensitivity is
$${S}_{y} ( T , P ) = \frac{[ M \cdot e ( T , P ) \cdot {λ}_{B} ( T , P ) ( 1 - {P}_{e} ) ] [ 2 L ( T , P ) {L}_{2} ( T , P ) - {L}_{2}^{2} ( T , P ) ]}{4 E ( T , P ) {I}_{y} ( T , P ) L ( T , P )} ;$$
and a third axial sensitivity is
$${S}_{z} ( T , P ) = \frac{M \cdot {λ}_{B} ( T , P ) ( 1 - {P}_{e} )}{E ( T , P ) A} , where$$
$${I}_{x} ( T , P ) = {I}_{x 0} ( 1 + {α}_{T} Δ T - {δ}_{w} P ) {( 1 + {α}_{T} Δ T - {δ}_{h} P )}^{3} , {I}_{x 0} = \frac{{w}_{0} {h}_{0}^{3}}{12}$$
is a first initial moment of inertia, and
$${I}_{y} ( T , P ) = {I}_{y 0} ( 1 + {α}_{T} Δ T - {δ}_{w} P ) {( 1 + {α}_{T} Δ T - {δ}_{h} P )}^{3} , {I}_{y 0} = \frac{{h}_{0} {w}_{0}^{3}}{12}$$
is a second initial moment of inertia.

2. The three-dimensional vibration fiber Bragg grating sensor for the engineering parameter sub for logging while drilling according to claim 1, wherein the fixing seat is fixedly connected to an inner surface of the shell, the mass block and the fixing seat are spaced apart, the slot penetrates through the mass block and the fixing seat of the same support assembly, end faces of the mass block and the fixing seat where the slot is formed are flush, and the cantilever beam is arranged between the mass block and the fixing seat and is fixedly connected to adjacent end faces of the mass block and the fixing seat respectively; the bend-insensitive optical fiber is fixedly connected to parts of the slot in the mass block and the fixing seat respectively; the grating region of the bend-insensitive optical fiber is suspended between the mass block and the fixing seat in a tensioned mode and is arranged at a gap with the cantilever beam; and the mass block and the cantilever beam are arranged at a gap with the inner surface of the shell.

3. The three-dimensional vibration fiber Bragg grating sensor for the engineering parameter sub for logging while drilling according to claim 2, wherein a thickness of the cantilever beam in the radial direction of the bend-insensitive optical fiber is less than a thickness of the fixing seat or the mass block in the radial direction of the bend-insensitive optical fiber, and mass of the cantilever beam is less than mass of the mass block.

4. The three-dimensional vibration fiber Bragg grating sensor for the engineering parameter sub for logging while drilling according to claim 3, wherein when a vibration signal of external drilling acts on the three sensing bodies, under action of inertia, one ends of the cantilever beams away from the fixing seats, and the mass blocks undergo axial offsets, compressing or stretching the grating regions on the three sensing bodies, so that a central wavelength of reflected light of the grating regions changes, and the vibration signal of external drilling is obtained by performing signal demodulation on the reflected light of the grating regions; and each mass block undergoing an axial offset is a rotation with respect to an end face, where the slot is formed, of the fixing seat of the sensing body where the mass block is located.

5. The three-dimensional vibration fiber Bragg grating sensor for the engineering parameter sub for logging while drilling according to claim 4, wherein a surface of the bend-insensitive optical fiber is bonded to an inner surface of the slot, or metal plating is arranged on a part of the surface of the bend-insensitive optical fiber located at the sensing body, and the metal plating is welded and fixed to the inner surface of the slot; and a depth of the slot is greater than a diameter of the bend-insensitive optical fiber, and a width of the slot is equal to the diameter of the bend-insensitive optical fiber.

6. The three-dimensional vibration fiber Bragg grating sensor for the engineering parameter sub for logging while drilling according to claim 4, wherein measurement wavelength ranges of the different grating regions do not overlap each other.

7. The three-dimensional vibration fiber Bragg grating sensor for the engineering parameter sub for logging while drilling according to claim 2, further comprising a plurality of installation blocks, the inner surface of the shell is provided with a plurality of placement grooves, and the plurality of placement grooves are spaced apart in the first preset direction; one ends of the installation blocks are embedded in the placement grooves, and the other ends extend out of the placement grooves and extend toward an interior of the shell; and the fixing seats are arranged at ends of the plurality of installation blocks away from the inner surface of the shell, and are fixedly connected to the installation blocks.

8. The three-dimensional vibration fiber Bragg grating sensor for the engineering parameter sub for logging while drilling according to claim 7, wherein spacing between the different fixing seats is greater than spacing between the corresponding installation blocks.

9. The three-dimensional vibration fiber Bragg grating sensor for the engineering parameter sub for logging while drilling according to claim 1, further comprising a cover plate, wherein the shell is provided with an opening, and the cover plate covers the opening.
